(19) United States
(12) Patent Application Publication
(10) Pub. No.: US 2003/0039735 A1
(43) Pub. Date: Feb. 27, 2003

(54) Gelatinized potato starch breading composition and process for manufacture

(76) Inventors: Kazuaki Morii, Nara (JP); Kiyoshi Morii, Nara (JP); Toshikiyo Hagiwara, Nara (JP); Frank Kluberspies, North Brunswick, NJ (US); Simpey Kuramoto, Ramsey, NJ (US); Doug Hasselo, Woodridge, IL (US)

Correspondence Address: Stephen B. Salai, Esq., Harter, Secrest & Emery LLP, 1600 Bausch & Lomb Place, Rochester, NY, 14604-2711, US

(21) Appl. No.: 10/200,415

(22) Filed: Jul. 22, 2002

Related U.S. Application Data
(63) Continuation-in-part of application No. 10/021,136, filed on Oct. 22, 2001.
Application No. 10/021,136 is a continuation-in-part of application No. 09/812,803, filed on Mar. 20, 2001, now Pat. No. 6,461,660.
(60) Provisional application No. 60/235,732, filed on Sep. 27, 2000.
(60) Provisional application No. 60/241,866, filed on Oct. 20, 2000.
(60) Provisional application No. 60/276,374, filed on Mar. 16, 2001.

(51) Int. Cl. A21D 13/00

(52) U.S. Cl. 426/559

(57) ABSTRACT

A coating composition for application to a food substrate is formed from a gelatinized, reduced pH mixture of potato starch and water. The mixture can be formed with a seasoning selected to reduce the pH, and is initially partially gelatinized, then formed into a sheet. The sheet is heat treated to gelatinize the starch. The sheet is cooled, and rendered into breading sized particles or pellets. The breading is dried to a moisture content between 7.5% and 19% by weight, and then applied to the food substrate for subsequent cooking or heating to puff the pellets, such that the resulting product can be frozen and reheated.

### RELATED APPLICATIONS

The present application is a continuation-in-part application of and claims priority to U.S. patent application Ser. No. 10/021,136 filed Oct. 22, 2001 which is a continuation-in-part application of and claims priority to U.S. patent application Ser. No. 09/812,803, filed on Mar. 20, 2001, and also claims benefit of U.S. Provisional Patent Application Serial No. 60/235,732, filed Sep. 27, 2000, U.S. provisional Patent Application Serial No. 60/241,866 filed Oct. 20, 2000, and U.S. Provisional Application No. 60/276,374 filed Mar. 16, 2001. Each of the aforementioned non-provisional and provisional applications is expressly incorporated herein by reference.

### FIELD OF THE INVENTION

The present invention relates to a coated food product, and more particularly, to a breading for a food substrate, wherein the breading includes puffable gelatinized starch based pellets, such that a pH of the gelatinized starch based pellets has been reduced. The present invention also includes methods of enhancing the adhering and puffing characteristics of potato starch based pellets on a food substrate.

### BACKGROUND OF THE INVENTION

The market for batter breading focuses on various forms of toasted bread crumbs, Japanese crumbs, puffed breakfast cereal and even coconuts to confer unique coatings to make fried foods. These fried foods include fish, seafood, poultry, red meat, vegetables, cheese and other food products served as fried products. The food business has been dependent on various forms of toasted breadcrumbs, Japanese crumbs, puffed breakfast cereals, and even coconuts to confer unique coatings to make fried foods more consumer acceptable. Normally, batter breading or crumbs are sold without any seasonings, or in case such products are claimed to be seasoned, flavors are merely added to the breading after formation of the breading and are not necessarily mixed within the breading matrix itself.

The coated food products are generally cooked before being frozen for distribution to restaurants and other institutional users. These frozen food products are reconstituted for consumption, but result in poor crispiness and color when reheated.

Therefore, the need exists for a breading composition that can provide enhanced mouth feel, texture color and taste upon heating, or reheating a breaded food substrate. The need also exists for a method of producing a breading, wherein the breading will puff or expand upon sufficient heating. A need further exists for a breading that is integrally formed with a desired seasoning. The need further exists for a breading having a homogeneous distribution of water and seasoning throughout a gelatinized starch matrix.

### SUMMARY OF THE INVENTION

The present invention relates to a breading formed of puffable, gelatinized potato starch based pellets, wherein the pellets can be used as a stand-alone breading or can be mixed with conventional batter systems. Furthermore, in contrast to prior breading products which are normally made of wheat or corn, the present invention primarily focuses on the use of potato starch.

The present method for preparing breading includes mixing potato starch, water and a pH lowering seasoning at a sufficient temperature to partially gelatinize the starch, forming the mixture into a sheet and subjecting the sheet to steam treatment to completely gelatinize the starch; rendering (such as shaping or grinding) the sheet to a desired pellet size and drying the pellets to a moisture content from 7-19%.

The inclusion of various seasonings at upwards of 0.5-20% within the gelatinized starch matrix confers a flavor and texture to breading not previously achievable with prior bread systems formulated from wheat flour, corn, rice or beans. It is believed the seasonings reduce the pH of the starch water mixture, such that the lower pH enhances the puffing characteristics of the gelatinized pellets.

The present process of sheet gelatinization of potato starch with a seasoning mixed within the gelatinized potato starch matrix provides enhanced flavor retention. In addition, the present breading exhibits enhanced retention to a batter and hence food substrate. The enhanced retention increases yield of the breading process, thereby reducing costs.

As used herein, the term “puffable” means the ability of the pellet to expand in volume, usually at least by twofold, within a short time, e.g., from several seconds to less than two minutes, when subjected to rapid heating. The expansion in volume can be from two fold to more than eight fold the original size. The rapid heating can be any of a variety of processes, including, but not limited to microwaving, hot air heating, e.g., by passing heated air at a temperature of about 400-480° F. over the pellets, or deep fat frying in oil that has been preheated to a temperature of at least 340 to 345° F. For example, the pellets fully expand (puff) in less than 15 seconds and preferably within about 8 to 12 seconds when fried in oil preheated to a temperature of approximately 360° F. The coated food product is easily cooked by such rapid heating to obtain a delicious crunchy coating.

### BRIEF DESCRIPTION OF THE DRAWINGS

FIG. 1 is a flow chart of the preparation of the breading.

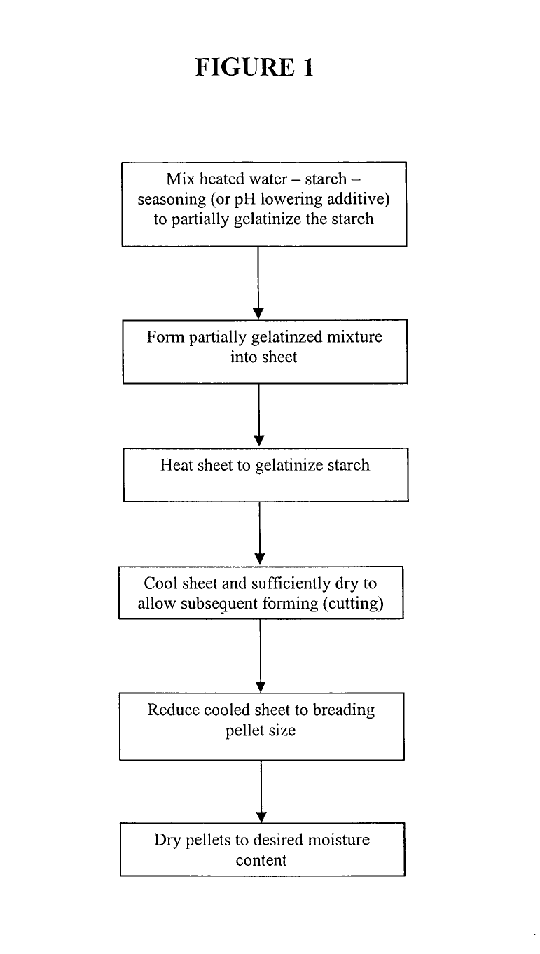

FIG. 2 is a flow chart of the application of the breading to a food product.

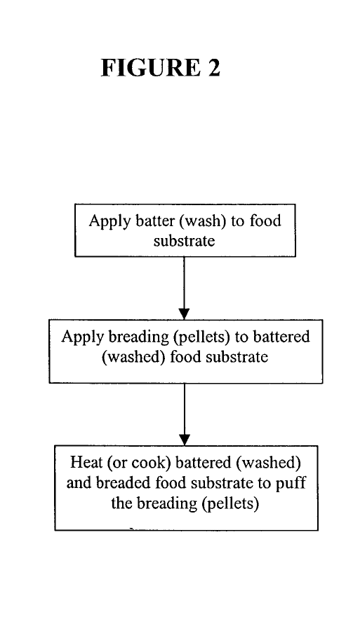

### DETAILED DESCRIPTION OF THE PREFERRED EMBODIMENTS

The present invention contemplates a coated food product. The coated food product includes a food substrate having a coating on at least a portion of the food substrate. The coated food product can be heated, frozen and subsequently reheated to provide a satisfactory mouth feel and visual appearance. The present coating allows for heating and/or cooking of the coated food product by any of a variety of mechanisms including deep fry, hot air, and microwave. The term coating is intended to include, but not be limited to a batter, a breading or a batter breading.

The food substrate can be any of a variety of substances such as poultry, beef (veal), seafood, pork, fruit or vegetable, including but not limited to, chicken, raw or precooked, marinated or unmarinated breast meat, drum sticks, thigh meat, pressed, light and dark meat, wings; turkey—breast cutlets, formed, strips; veal/beef—strips, marinated and coated; pork—ribs, chops, sausage, tenderloin; seafood—shrimp, clams, crabs, fish, oysters; vegetables—peppers, onions, eggplant; and fruit—bananas, peaches, apples.

Generally, the coating is a breading formed of pellets of gelatinized starch, with a specific embodiment having a reduced pH, through the introduction of a relatively acidic seasoning. The pellets are a gelatinized seasoned starch, having a moisture content between approximately 7.5% to 19%, and a particle size between approximately 0.6 to 1.2 mm×1.5 to 2.5 mm, with a thickness of about 1.0 to 1.4 mm.

The pellets forming the breading are formed from a gelatinized sheet of starch, where the gelatinized sheet is formed from a mixture of potato starch, water and a relatively acidic additive such as a seasoning. The potato starch used in the present invention is basically known as 100% starch product with only trace amounts of protein. Although potato starch has provided the most desirable results, it is understood other starches can be employed, including but not limited to rice, rice powder, tapioca, corn, bean, mung beans as well as their modified starches. Further, blends of potato starch and any of these starches could be employed. While, the present embodiment has been described in terms of the starch from potatoes, rice, beans, it is contemplated that relatively unprocessed potatoes, rice, beans or corn may be used. That is, rather than employing a 99.5% or higher starch content, a lower starch content percentage could be used.

The term seasoning encompasses flavorings. Flavorings are generally flavor chemical compositions having a distinctive taste such as extracts or spices including, but not limited to, salt, sugar, savory (including but not limited to chili powder, jalapeno powder, whey powder, paprika, cocoa powder), fruit, vegetable, dairy, chocolate, meat, etc. In contrast, a seasoning typically includes at least one flavoring and usually a mixture of flavorings as well as glucose polymer stabilizer. Exemplary seasonings include, but are not limited to, sour cream and onion, BBQ, salt and vinegar, Mexican Chipotle, chicken, beef, pork, turkey, cheese, vegetable, etc. In order to obtain optimal breading characteristics, various seasonings and flavors can be mixed within the potato starch matrix.

It is contemplated that several different seasonings can be used in the method of the present invention. The seasoning can include salt and vinegar, vinegar, barbecue seasoning, nacho seasoning, sour cream and onion seasoning, sweet and sour seasoning, sweet seasoning, hot and spicy seasoning, chicken flavor seasoning, savory flavor seasoning, fruit seasonings, citrus seasoning, vegetable seasonings, monosodium glutamate (MSG), hydrolyzed vegetable proteins (HVP), yeast autolysates, flavor reaction products and other natural and artificial flavored seasonings such as fruit, vegetable and dairy flavored seasonings.

It is believed that the pH of a seasoning lower than the pH of the starch-water mixture to which the seasoning is added provides enhanced puffability. That is, the seasoning lowers the pH of the starch-water mixture. It has been found that starch-water mixtures with reduced pH provide enhanced puffing characteristics of the resulting pellets. Although an edible acid could be employed, it has been found that seasoning provides an enhanced taste in conjunction with the puffing. The starch and seasonings (pH reducing additive) are mixed with preheated water at a temperature to emulsify the mixture and homogeneously distribute the seasoning. In the case of using potato starch as the base starch, the preheated water temperature should be about 55° C. to 65° C., and preferably, from about 59° C. to 61° C. to effect partial gelatinization. The starch must not completely be gelatinized in this step, since the mixture increases in viscosity with increased gelatinization, and the mixture must be sufficiently pourable to form into a sheet. If the temperature of heated water is too high, the compound will result not pourable as its viscosity increases. On the other hand, if the water temperature is too low, it will not allow the starch to initialize gelatinization and will result in poor emulsification. The potato starch, water and seasoning can be mixed using variety of methods. In a case of using a jacket mixer, mixing time is from about 5 to 10 minutes. Preferably, the mixing homogeneously distributes the seasoning and water throughout the mixture.

The partially gelatinized mixture is then formed onto a sheet. This is generally accomplished by pouring the mixture into a flat pan tray or onto a conveyor or roller belt for continuous processing. The thickness of the sheet is generally in the range from about 0.9 mm to 1.8 mm, with a preferred range of about 1.0 mm to 1.8 mm, prior to the steam treatment. More preferably, the sheet thickness prior to the steam treatment is from about 1.2 mm to 1.6 mm. The thickness of the sheet prior to the steam treatment is critical, as it affects the thickness of the final product since the pellets are dried after the cutting. Thus, the thickness of the dried pellets corresponding to the above presteaming thickness, respectively, having a thickness from about 0.8 mm to 1.6 mm, preferably from about 1.0 mm to 1.4.

After the mixture is formed into the sheet, the sheet is subjected to a steam treatment. The exposure to the steam treatment effects complete gelatinization of the mixture. The steam treatment is carried out by contacting the sheet with steam for a period of time to produce, at least, substantially complete gelatinization. The steam treatment can be achieved by placing the sheet into a batched steam oven system, steam tunnel in case of continuous process, or other procedures well known in the art. The steam treatment can be carried out under atmospheric pressure. The amount of time required for the steam treatment depends on the thickness of the sheet and source of the starch. Generally, the steam treatment is carried out for about 1 to 7 minutes at a steaming temperature of about 97° C. to 100° C. Longer steaming may occasionally result in producing unevenness in the surface of the sheet, for example, craters may form in the surface. Preferably, the steaming time is about 1 to 6 minutes for a continuous or in-line process, and about 3 to 6 minutes for a batch steamer. The most preferred time required for steaming is from about 3 to 6 minutes. It is understood alternative heating can be employed, including but not limited to ovens.

After the steam treatment, the sheet is cooled and allowed to at least partially dry. The drying can be by air drying or heating. It is important that the sheet be dried only to the extent necessary such that the sheet can be rendered (cut or formed) into the desired pellet size for a breading. Thus, if the gelatinized sheet is dried too much, the sheet can become too brittle so that when the sheet is shaped, as by die cutting, the pellets will fracture. The degree of dryness is easily adjusted by the skilled artisan to achieve the desired results, i.e., size and shape of the pellets. The most preferred method of drying the gelatinized sheet is to expose the sheet to a fan for about 15 to 20 minutes, then, let the sheet set for about 12 to 24 hours under ambient temperature before particulating the sheet, such as by die cutting or grinding.

The product is die cut to obtain pellets of uniform sizes and shapes. However, grinding can be employed to provide a given size distribution about nominal size. That is, in some applications, there is a consumer preference for non uniform pellet sizes. The distribution of pellet sizes can be selected to be relatively narrow or relatively broad.

The term “pellet” is used to encompass all three dimensional shapes, such as spheres, ellipses, cubes, blocks and solid or hollow rods or cylinders having any cross-sectional area. “Pellets” also encompasses irregular shapes such as flat chips, flakes, double chips, crinkle cuts, and the like. For example, three dimensional shapes, such as spheres, ellipses, cubes, “S”-shapes, spirals, and solid or hollow rods or cylinders having any cross-sectional area can be used. Rods and cylinders, both solid and hollow, can have cross-sections that include circles, ellipses, squares, pentagon, hexagon, any polygon, stars, and the like. The surfaces may be smooth or may have a serrated or corrugated surface. Irregular shapes such as flat chips, flakes, double chips, crinkle cuts, bow ties, and the like can also be used, as well as irregular shapes that cannot be characterized as anything but random and irregular.

The cut particulates, such as pellets (breading) are then dried at 60° C. to 70° C. to obtain a given moisture content. Usually, the finished product has a breading has a moisture content in the range from about 1 to 20% moisture with a preferred range of about 7.5 to 19% by weight, with a more preferred moisture content from about 8 to 16%.

The ideal size of cut pieces before drying is about 1.0 to 1.4 mm×2 to 3 mm so that final dried products will result in the sizes from about 0.65 to 1.2 mm×1.5 to 2.5 mm, with having the thickness at about 1.0 to 1.45 mm. The product of the present invention exhibits excellent puffing characteristics when rapidly heated, e.g. in a microwave oven, hot air popper or when subjected to deep fat frying.

It is possible to toast the pellets prior to application to the food substrate. A satisfactory toasting renders the pellets a golden brown color. Exposure to a 350° F. oven for two to five minutes can provide the toasting. It is believed the toasted pellets may reduce gumminess of breading upon frying.

The following examples are provided to assist in further understanding the present invention. The particular materials and conditions employed are intended to be further illustrative of the invention and are not limiting upon the reasonable scope thereof.

### EXAMPLE 1

A puffable pellet for breading including sour cream and onion seasoning as well as salt and vinegar seasoning was prepared in the same manner as the procedure described above, except that sour cream and onion seasoning as well as salt and vinegar seasoning was added to the matrix of the potato starch instead of just simply adding potato starch with water. The sour cream and onion seasoning, and salt and vinegar seasoning had the compositions shown in Table 1 and 2, respectively.

TABLE 1
Sour Cream and Onion Seasoning

| Ingredient | Weight % of the Composition |
|---|---|
| Whey Powder | 28 |
| Salt | 15 |
| NFDM | 10 |
| Buttermilk Powder | 10 |
| Sour Cream Powder | 10 |
| Citric Acid | 1 |
| Whey PTX | 5 |
| Flavor | 21 |

TABLE 2
Salt and Vinegar Seasoning

| Ingredient | Weight % of the Composition |
|---|---|
| Maltrin | 50.0 |
| Salt | 29.0 |
| Essicum Vinegar | 15.0 |
| Vinegar Powder | 3.0 |
| Citric Acid | 3.0 |

An exemplary sour cream flavoring is as follows:

TABLE 3
Sour Cream Flavoring

| Ingredient | Weight % of the Composition |
|---|---|
| Cream Cheese Type Natural O.S. | 7.50 |
| Sour Cream Flavor Type Natural O.S. | 10.00 |
| Acetic Acid Glacial | 17.00 |
| Massoi Lactone | 0.04 |
| Processed Cheese Flavor Type | 0.4 |
| Natural O.S. | |
| Onion Oil | 0.5 |
| Garlic Oil .1% in Neobee M5 | 0.5 |
| Methional .1% in Neobee M5 | 0.5 |
| Mustard Oil 10% in Neobee M5 | 0.25 |
| Methyl ThioButyrate 1. in Neobee M5 | 0.1 |
| Sulfurol 1.% in Neobee M5 | 0.3 |
| Gamma Butyrolactone | 0.6 |
| 1 Octen 3ol .1% in Neobee M5 | 0.5 |
| Neobee M5 | 61.81 |
| Total | 100.00 |

As an example, the following formula was used as described in Table 4.

TABLE 4

| Ingredient | Weight % of the Composition |
|---|---|
| Water | 50.3 |
| Potato Starch | 42.1 |
| Sour Cream & Onion Seasoning | 6.3 |
| Salt & Vinegar Seasoning | 1.3 |

The potato starch and water mixtures generally have a pH around 6.0. to approximately 7.0 or slightly higher. Upon adding the seasonings, the resulting starch-water-seasoning mixture has a pH of less than 6.0 and preferably less than approximately 5.5. It is believed, a breading can be formed without added flavoring, wherein sufficient acid is added to the starch water mixture to reduce the pH prior to gelatinization.

The sheets formed from the mixture of potato starch, water and seasoning (sour cream and onion seasoning, salt and vinegar seasoning), were steamed and cooled and then pre-dried die cut to form 1.4 mm×2.5 mm pieces. Then, the pellets were dried to obtain a 8% to 16% moisture content, and the size of the square shaped pellets was reduced to about 1 mm×2 mm.

In use, the dried seasoned breading pellets expanded within 30 seconds by deep fat frying in oil heated to 360° F. As an example, die cut pellets with 2.5 cm×2.5 cm after being dried, were fried in oil set at 360° F. and were fully expanded in less than 15 seconds, and preferably within about 8 to 12 seconds. However, it is understood a lower oil temperature, approximately 345° F. to 350° F. can be used to puff the pellets, wherein the puffing time of the pellets is on the order of 30 to 35 seconds. Alternatively, an oil temperature of 375° F. to 380° F. can be used, wherein the puffing time of the pellets is less than 15 seconds. These gelatinized flavored pellets are also expandable by using microwave heat and hot air popping equipment.

As for the breading application, the ideal size is to obtain 0.6 to 1.2 mm×1.5 to 2.5 mm having the thickness at about 1.0 to 1.4 mm after being dried to obtain 8 to 16% moisture in the product. Examples 2 and 3 below are provided to assist further understanding the present invention.

The breading (pellets) can be applied to the food substrate by any of a variety of manners. The breading can be applied by dipping, spraying, rolling or cascade. For purposes of illustration, Examples 2 and 3 of breading application are set forth.

### EXAMPLE 2

In the second example, the food substrate is coated with the breading in a two pass system. In the two pass system, the food substrate is exposed to a milk wash. The milk wash can be applied by any of a variety of mechanisms, including dipping, spraying, rolling or cascade. The milk wash is preferably approximately 5-7% by weight of the food product. The milk wash can be any of a variety of compositions. A satisfactory composition is approximately 6%-12% waxy maize corn starch, approximately 1-3% salt and the balance water.

Subsequently, the breading is coated on the food substrate. The breading can be applied by dipping, spraying, rolling or cascade. The breading can be approximately 10 to 40% by weight of the food product. The balance of the food product is the food substrate. It has been found that breading formed by the present process exhibits enhanced retention of the food substrate. That is, drop off or bare areas are significantly reduced. The enhanced retention is also exhibited during the cooking (puffing) process, as the breading forms a substantially continuous layer about the food substrate.

The coated food substrate is then allowed to rest, such as 1 to 5 minutes. Subsequently, the coated food substrate (food product) is cooked, by any of a variety of mechanisms including pan fry, deep fry, microwave, convection or oven.

While the cooked, coated food product can then be consumed, in commercial applications, the cooked, coated food product is then frozen and packaged (or packaged and frozen) for distribution.

### EXAMPLE 3

In the third example, the food substrate is initially dusted with flour. The flour can comprise approximately 4 to 5% by weight of the food product. The dusted food substrate is then exposed to a milk wash.

The milk wash can be applied by any of a variety of mechanisms, including dipping, spraying, rolling or cascade. The milk wash is preferably approximately 5-7% by weight of the food product. The milk wash can be any of a variety of compositions. A satisfactory composition is approximately 6%-12% waxy maize cornstarch, approximately 1%-3% salt and the balance water.

Subsequently, the breading is coated on the food substrate. The breading can be applied by dipping, spraying, rolling or cascade. The breading can be approximately 10 to 40% by weight of the food product. The balance of the food product is the food substrate.

The coated food substrate is then allowed to rest, such as 1 to 5 minutes. Subsequently, the coated food substrate is cooked, by any of a variety of mechanisms including pan fry, deep fry, microwave, convection or oven.

While the cooked, coated food product can then be consumed, in commercial applications, the cooked, coated food product is then frozen and packaged (or packaged and frozen) for distribution.

It is also contemplated, the pellets can be directly applied to the food substrate, without employing a batter or wash. The starch content of the pellet is believed to enhance direct adherence to the food substrate. While moisture from the food substrate may be sufficient, water can be applied to the food substrate prior to application of the pellets.

The present pellets can provide the entire coating. Alternatively, the pellets can be combined with conventional, non-puffing breading. The conventional breading can be from a few percent to 80% by weight of the breading combination, with the present pellets comprising the balance. That is, the present pellets may be 20% to 100% of the coating on the food substrate.

While the invention has been described in connection with what is presently considered to be the most practical and preferred embodiments, it is to be understood that the invention is not to be limited to the disclosed embodiment, but on the contrary, is intended to cover various modifications and equivalent arrangements included with the spirit and scope of the appended claims which scope is to be accorded the broadest interpretation so as to encompass all such modifications and equivalent structures.

In the claims:

1. A food product, comprising:
(a) a food substrate; and
(b) a coating on at least a portion of the food substrate, the coating including a multitude of gelatinized seasoned potato starch pellets having a moisture content between 1% to 19% by weight of the pellets.

2. The food product of claim 1, wherein the seasoned potato starch pellets have a lower pH than the potato starch.

3. The food product of claim 1, wherein the pellets are puffed.

4. The food product of claim 3, wherein the puffed pellets are frozen.

5. The food product of claim 1, wherein the pellets have a particle size of 0.65 to 1.2 mm×1.5 to 2.5 mm×1.0 to 1.45 mm.

6. The food product of claim 1, further comprising a liquid wash on the food substrate, the pellets adhering to the liquid wash and the food substrate.

7. The food product of claim 6, wherein the liquid wash includes milk.

8. The food product of claim 1, further comprising a batter on the portion of the food substrate.

9. The food product of claim 1, further comprising a starch derived from at least one of rice, rice powder, tapioca, corn, beans and mung beans.

10. A food product, comprising:
(a) a food substrate; and
(b) a puffable coating on at least a portion of the food substrate.

11. The food product of claim 10, wherein the coating includes a multitude of pellets of a gelatinized mixture of starch, water and an acidic additive.

12. The food product of claim 10, wherein the coating includes potato starch.

13. The food product of claim 10, wherein the coating has a moisture content between 7.5% to 19% by weight prior to puffing.

14. The food product of claim 10, wherein the coating includes potato starch and a seasoning.

15. The food product of claim 10, further comprising a batter on the portion of the food substrate.

16. The food product of claim 10, wherein the coating includes of potato starch and a starch from at least one of rice, rice powder, tapioca, corn, beans and mung beans.

17. The food product of claim 10, wherein the coating fully puffs within approximately 15 seconds in oil preheated to 360° F.

18. The food product of claim 10, wherein the coating includes a homogeneously distributed seasoning and water.

19. The food product of claim 10, wherein the coating includes a gelatinized mixture of starch and water, the mixture having a pH less than 6.

20. The food product of claim 10, further comprising a non puffable breading on the portion of the food substrate.

21. A food product, comprising:
(a) a food substrate; and
(b) a multitude of puffed starch based pellets on at least a portion of the food substrate.

22. The food product of claim 20, wherein the pellets include a gelatinized mixture of potato starch, water and an acidic additive.

23. The food product of claim 20, wherein the pellets have a moisture content between 7.5% to 19% by weight prior to heating.

24. The food product of claim 20, wherein the pellets include a gelatinized mixture of starch, water and an acidic additive.

25. The food product of claim 24, wherein the acidic additive is a seasoning.

26. The food product of claim 20, further comprising a batter on the portion of the food substrate.

27. The food product of claim 20, wherein the pellets include potato starch and a starch derived from at least one of rice, rice powder, tapioca, corn, beans and mung beans.

28. The food product of claim 20, wherein the pellets include a gelatinized mixture of potato starch and water, the mixture having a pH less than 6.

29. The food product of claim 29, further comprising a non puffable breading on the portion of the food product.

30. A method of preparing a food product, comprising:
(a) contacting a multitude of edible pellets with a food substrate, the edible pellets formed from a steam treated sheet of partially gelatinized mixture of potato starch, an acidic additive and water, wherein the edible pellets have a moisture content between 1.0% to 19% by weight of the pellets.

31. The method of claim 30, further comprising employing a seasoning as the acidic additive.

32. The method of claim 30, wherein contacting the pellets with the food substrate includes contacting the pellets with a batter.

33. The method of claim 30, further comprising mixing a starch derived from at least one of rice, rice powder, tapioca, corn, beans and mung beans with the potato starch.

34. The method of claim 30, further comprising reducing the pH of the mixture to less than 6 prior to gelatinization.

35. The method of claim 30, further comprising toasting the multitude of edible pellets prior to contacting with the food substrate.

36. The method of claim 30, further comprising rendering the multitude of edible pellets to a particle size distribution prior to contacting with the food substrate.

37. A method of preparing a food product, comprising:
(a) puffing a coating of gelatinized starch based pellets on a surface of a food product.

38. The method of claim 37, further comprising drying the gelatinized starch based pellets to a moisture content between 7.5% to 19% by weight of the pellets prior to puffing.

39. The method of claim 37, further comprising reducing a pH of the starch based pellets prior to gelatinization.

40. The method of claim 37, further comprising freezing the food product after puffing the pellets.

41. The method of claim 37, further comprising forming the pellets to provide puffing of the pellets within 15 seconds of exposure to oil at 360° F.

42. The method of claim 37, further comprising forming the pellets from potato starch.

43. The method of claim 37, further comprising forming the pellets from potato starch and a starch of at least one of rice, rice powder, tapioca, corn, beans and mung beans.

44. The method of claim 37, further comprising reducing a pH of the starch based pellets to less than 6 prior to gelatinization.

45. The method of claim 37, further comprising toasting the pellets prior to puffing.

46. A method of preparing a food product, comprising:
(a) contacting a multitude of edible pellets with a food substrate, the edible pellets formed from a steam treated sheet of partially gelatinized mixture of starch, water and an acidic additive.

47. The method of claim 46, wherein the edible pellets have a moisture content between 7.5% to 19% by weight of the pellets.

48. The method of claim 46, further comprising employing a seasoning as the acidic additive.

49. The method of claim 46, further comprising forming the pellets from potato starch.

50. The method of claim 46, further comprising forming the pellets from potato starch and a starch from at least one of rice, rice powder, tapioca, corn, beans and mung beans.

51. The method of claim 46, further comprising reducing the pH of mixture to less than 6.
